(19) United States
(12) Patent Application Publication
(10) Pub. No.: US 2009/0119215 A1
(43) Pub. Date: May 7, 2009

(54) SECURE E-PAYMENTS

(75) Inventors: Yuqun Chen, Seattle, WA (US); Yacov Yacobi, Mercer Island, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/936,259

(22) Filed: Nov. 7, 2007

(51) Int. Cl. H04L 9/00; G06Q 20/00; G06Q 30/00

(52) U.S. Cl. 705/53; 705/51; 705/64; 705/71

(57) ABSTRACT

Systems and methods that supply a fair transaction when a user (e.g., buyer) obtains digital content that is ordered from a merchant. A trusted component associated with a device of a user can compute a cryptographic hash value for the digital content (e.g., during a download thereof), wherein such hash value cannot be altered (e.g., tampered) by the user. Accordingly, the subject innovation implements a trusted agent on a user's device, wherein such agent itself can further be downloaded to the user device as part of the transaction.

### BACKGROUND

Electronic commerce depends in large part upon the successful and secure processing of consumer payments, wherein payment processing typically includes the process of settling charges with payment providers, such as Visa® and MasterCard®, and the like. Conventionally, a consumer browses a website and selects items for purchase by placing them in a virtual shopping cart. The consumer can subsequently supply identifying information, shipping address, as well as payment information by completing a form, for example. Such form and associated captured information can then be transmitted to a merchant.

Merchant operation personnel such as a web master can receive the transferred information, parses the data, and transmits the information to payment providers. As such, the payment provider can supply authorization to the merchant and subsequently credit the merchant's account or debit the authorized party's account. Typically, such process can be conventionally completed on a daily basis at a predetermined time. For example, files are transmitted to payment providers at night (e.g., 10 p.m.) and responses received from the providers are processed in the morning (e.g., 8 a.m.). Such can prove inefficient and can unnecessarily strain a system at inopportune times, for example where the system is encountering high system loads. Further, conventional payment processing systems are manually driven by business operations personnel and thus require operation personnel to be present throughout the entire payment and reconciliation process. Conventional payment processing and reconciliation systems, therefore have a very high cost of processing per transaction due to many inefficiencies including, inter alia, processing independent of system load and constant monitoring and interaction by operation personnel.

Accordingly, electronic payment systems can resemble conventional payment systems, having at least the usual nodes: a payer, a payee, and a bank, using mechanisms similar to ordinary checks, credit, debit, and cash. Security lapses can occur inside a node or between nodes. Such can arise from faulty man-machine communication, and from faulty or compromised machinery. Additional problems can further include payer-payee disputes, wherein purchased digital content does not match its title, or the usual disputes about payments and delivery.

Moreover, pre-requisites for proper secure e-commerce are proper merchant authentication, and proper payer authentication (e.g., for non-anonymous secure payment system). For example, impersonation can occur due to either inter or intra node security failures.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation facilitates ensuring a fair transaction when a user (e.g., buyer) obtains digital content that is ordered from a merchant, and the merchant receives payment for the digital content, via employing a trusted component that is associated with a device of a user. Such trusted component can compute a cryptographic hash value (and/or signed cryptographic hash) for the digital content (e.g., during a download thereof), wherein typically such hash value cannot be altered (e.g., tampered) by the user. Accordingly, the trusted component can act as a trusted agent on a user's device, wherein the trusted component itself can further be downloaded to the user device as part of the transaction.

In a related aspect, the user can supply payment to a trusted third party, such as to tie verification for the downloaded component to payments—hence mitigating frauds and disputes between merchants and users. As such, a user can connect to a merchant's site, wherein a down load of the digital content occurs. The user's device can then compute a hash for the downloaded digital content. Moreover, the cryptographic hash can be computed on the user's machine, and such hash can further be included as part of a transaction log (e.g., key available). Subsequently, the computed hash of the digital content can be sent in conjunction with payments to a trusted third party. Upon receipt of the hash content by the trusted third party, such third party can then look up a published list of hash values and digital content, to verify that a correct match exists. By verifying the proper downloaded content with associated payment, a key can then be supplied to the user. Hence, the third party can check mapping of the hash values, to ascertain user's receipt of the digital content.

According to a further aspect, a logging component associated with the user device can maintain a log for the downloaded digital content and supply a comparison between a log viewed by the user device and the log used on a server associated with the third party. Such can typically ensure a fair transaction, wherein the merchant cannot over charge or create spurious transactions and/or user allege lack of receipt for the digital content.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a trusted component that facilitates ensuring a fair transaction in accordance with an aspect of the subject innovation.

FIG. 2 illustrates a system that implements a trusted third party entity in conjunction with the trusted component in accordance with an aspect of the subject innovation.

FIG. 3 illustrates a particular aspect of a download for digital content via a trusted component in accordance with an aspect of the subject innovation.

FIG. 4 illustrates the composition of a digital content that can be downloaded and assembled with hash creation in accordance with a particular aspect of the subject innovation.

FIG. 5 illustrates a related methodology that typically ensures a fair transaction between a user of digital content and a merchant in accordance with an aspect of the subject innovation.

FIG. 6 illustrates a related methodology of hash implementation via a trusted third party in conjunction with comparison of computed hash values in accordance with an aspect of the subject innovation.

FIG. 7 illustrates an artificial intelligence component that can be employed to facilitate a download in accordance with an aspect of the innovation.

FIG. 8 illustrates a wireless mobile device that can receive a download of digital content in accordance with an aspect of the subject innovation.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

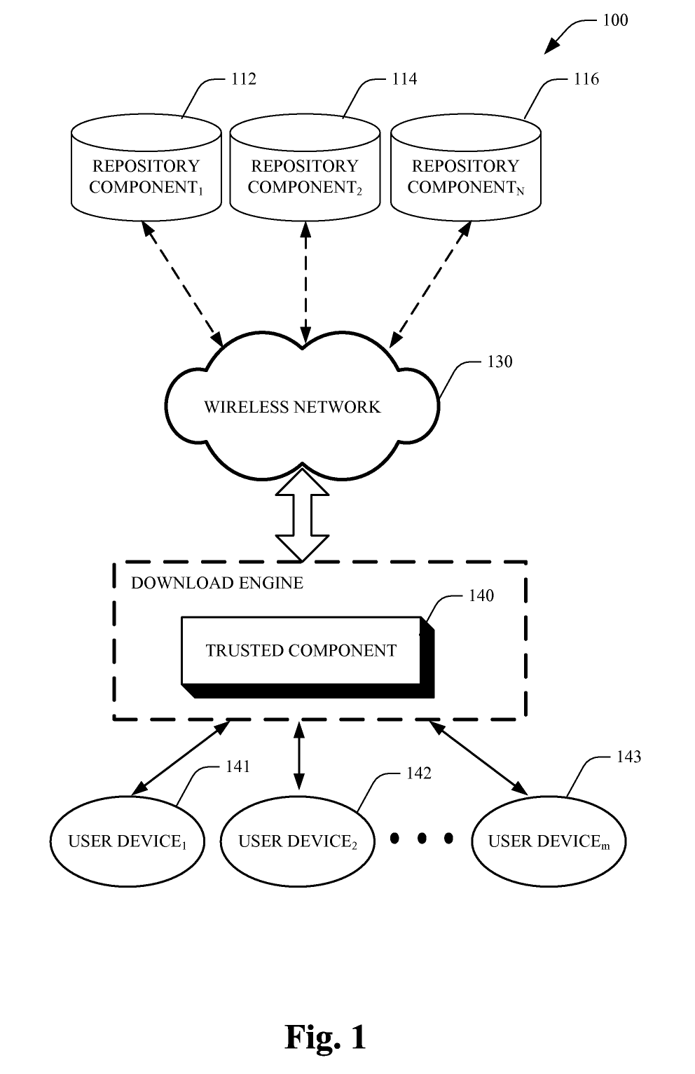

FIG. 1 illustrates a block diagram of a trusted component 140 that facilitates ensuring a fair transaction, wherein a user (e.g., buyer) obtains digital content that is ordered from a merchant thru repository components 112, 114, 116, (1 thru N, where N is an integer) and the merchant receives payment for the digital content. The trusted component 140 can compute a cryptographic hash value for the digital content (e.g., during a download thereof), wherein typically such hash value cannot be altered (e.g., tampered) by the user. Accordingly, such trusted component 140 can act as a trusted agent on a user's device, wherein the trusted component 140 itself can further be downloaded to the user device as part of the transaction.

The repository components 112, 114, 116 can include any type of a device with storage capabilities and a memory that can include read only memory (ROM) and random access memory (RAM). The ROM contains among other code the Basic Input-Output System (BIOS), which can control the basic hardware operations of the repository components 112, 114, 116, and the RAM can function as the main memory into which the operating system and application programs can be loaded. The repository components 112, 114, 116 can also serve as the storage medium for storing information and additional metadata related to the digital content such as; genre; user ranking, purchase info, number of times downloaded or played, ratings and related data. For mass media file storage, the repository components 112, 114, 116 can include a hard disk drive (e.g., 10 Gigabyte hard drive), and the like.

The repository components 112, 114, 116 can also be associated with a network (e.g., wireless network 130) such as a system area network or other type of network, and can include several hosts, (not shown), which can be personal computers, servers or other types of computers. Such host generally can be capable of running or executing one or more application-level (or user-level) programs, as well as initiating an I/O request (e.g., I/O reads or writes). In addition, the network can be, for example, an Ethernet LAN, a token ring LAN, or a Wide Area Network (WAN). Moreover, such network can also include hardwired and/or optical and/or wireless connection paths. The connections can be shared among a plurality of the repository components 112, 114, 116 that store digital files for sale to the user. Likewise, the user devices 141, 142, 143 (1 thru m, m being an integer) can include intelligent devices personal computers, workstations, televisions, telephones, and the like for example. Moreover, the wireless network 130 can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters. Moreover, the wireless communication network 130 can be cellular or WLAN communication network; such as Global System for Mobile communication (GSM) networks, Universal Mobile Telecommunication System (UMTS) networks, and wireless Internet Protocol (IP) networks such as Voice over Internet Protocol (VoIP) and IP Data networks

The user device 141, 142, 143 can be a hand-held wireless communication device that can communicate with a wireless communication network, (e.g. wireless communication network 130) to upload and download digital content, via a cellular access point and/or via a wireless access network (WLAN) access point, such as a cellular base station, mobile switching center, 802.11x router, 802.16x router and the like. Further examples of the portable user device 141, 142, 143 can include a cellular communication device, a multi-mode cellular device, a multi-mode cellular telephone, a dual-mode cellular device, a dual-mode cellular/WiFi telephone, or like cellular and/or combination cellular/fixed internet protocol (IP) access devices.

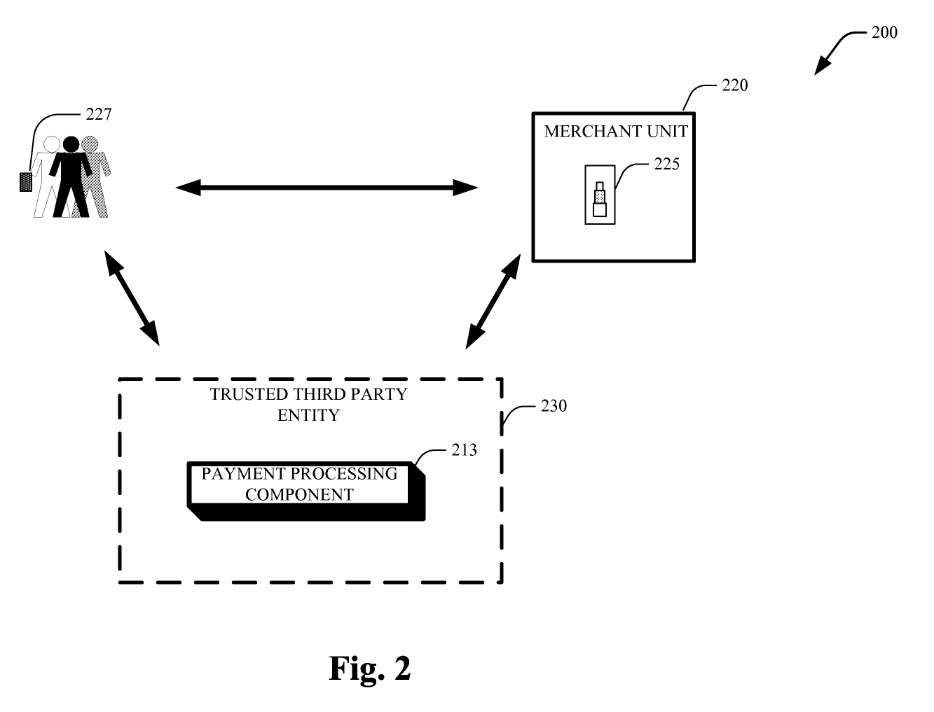

FIG. 2 illustrates a system 200 that implements a trusted third party entity in conjunction with the trusted component in accordance with an aspect of the subject innovation. As illustrated in FIG. 2, the user(s) with portable device(s) 227 can supply payment to a trusted third party, such as to tie the verification of the downloaded component to payments—hence mitigating frauds and disputes between merchants and users. As such, the device 227 can connect to a merchant's site, when a down load of the digital content occurs. The user's device 227 can then compute a hash for the downloaded digital content. The cryptographic hash (e.g., signed cryptographic hash) can be computed on the user's device 227, and such hash can further be included as part of a transaction log (e.g., key available). Subsequently, the computed hash of the digital content can be sent in conjunction with payments to the trusted third party entity 230. Such a network can be implemented in connection with a commercial transaction (e.g., for a retail, electronic web purchases, grocery stores, and the like) and can include proprietary network transaction data flows on payment gateways, which take payment requests from merchant and route such request to proper processing entities, for example.

In general, payment processing component 213 can settle charges with payment providers (e.g., Visa® and MasterCard®), as well as the merchant unit 220, which can further include: a central host computer operatively connected to a plurality of in-store customer sale terminals 225 that can represent point of sale (POS); a wireless local area network that includes a plurality of access points; and a wired backbone for communicating data between the central host and the customer sale terminals (not shown).

Upon receipt of the hash content by the trusted third party entity 230, such third party can then look up a published list of hash values and digital content, to verify that a correct match exists. Upon verification of the proper downloaded content and associated payment, a key can then be supplied to the user device 227. As such, the third party entity 230 can check mapping of the hash values, to ascertain user's receipt of the digital content. Moreover, a logging component (not shown) associated with the user device 227 can maintain a log for the downloaded digital content and supply a comparison between a log viewed by the user device and the log used on a server associated with the trusted third party entity 230. Such can typically ensure a fair transaction, wherein the merchant cannot over charge or create spurious transactions and/or user allege lack of receipt for the digital content.

For example, in context of purchasing digital music, to play a song one requires permission from the trusted component. Such permission can be granted if the trusted component has evidence that the song is obtained legally. The trusted component acts substantially similar to a trusted third party, wherein the payment and digital goods exchange occurs therein. More specifically, when the vendor sends the goods to the trusted component, the latter can keep a record of the transaction (including the secure hash of the content and payment amount) and transmit payment authorization to the vendor. The records can be maintained in cryptographically secure fashion, so that a malicious user cannot tamper therewith. Example of the secure record can include signing the record using the module's secret key. Likewise, in case of a dispute, a secure channel can be established between a “judge” machine (not shown)—and the trusted component. A log of all associated transactions can subsequently be exchanged, (e.g., signed hashes of songs), to establish legal purchases.

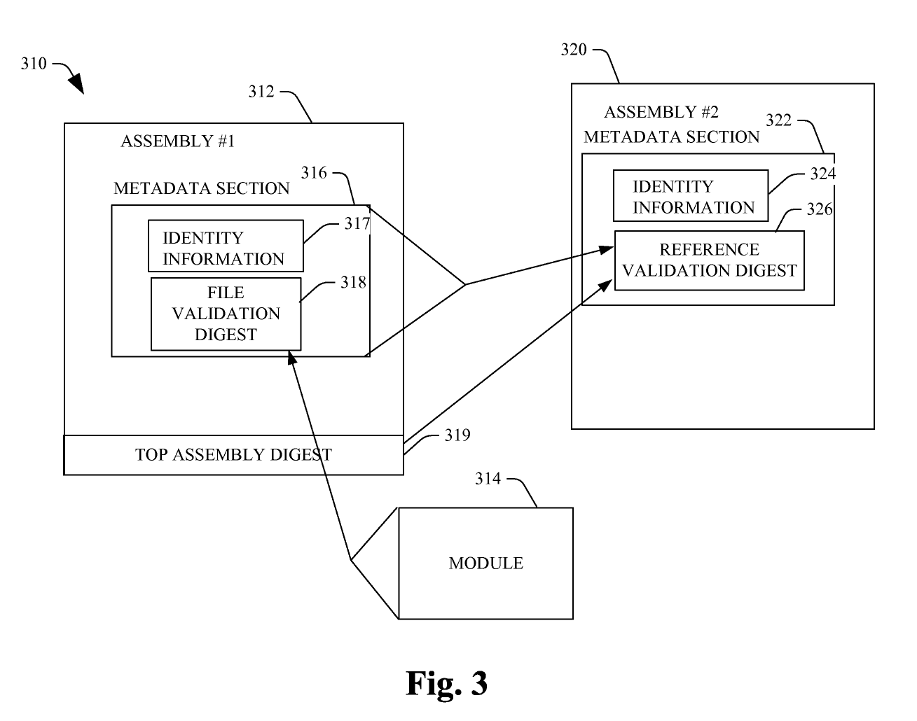

FIG. 3 illustrates a particular aspect of a download for digital content via a trusted component in accordance with an aspect of the subject innovation. The digital content can include a first assembly 310 including a top assembly 312 (e.g., a file with a metadata section or manifest) and a module or subassembly 314. Typically, each assembly of the digital content can be provided with a manifest that contains a list of files or modules that make up the assembly. Part of the information recorded about each file can include a hash of the file's contents at the time the manifest was built. The hash is computed over the entire contents of the file. The code that emits the manifest can typically include a compiler or a post-link tool, which can be responsible for computing the hash. The subject innovation can implement a variety of hash algorithms, such as secured hash algorithm (sha-1), MD5, or any other cryptographically suitable hash algorithm in computing the hash. In one aspect of the innovation, the creator of the manifest can specify which hash algorithm that the creator would like employed. The file hashes can be verified when an assembly is installed into a global assembly cache and each time a file is loaded from a disk.

The file hashes described above facilitate integrity of the deployable digital content (e.g., the assembly). Some applications are comprised of several assemblies. Therefore, to ensure integrity of the entire application it is necessary to confirm not only that each individual assembly has not changed, but that the set of assemblies used by the application program at runtime are the same set that were previously built and tested together. Accordingly, in one aspect of the innovation, an assembly referencing another assembly can compute the hash of the manifest of the referenced assembly. An assembly manifest can include dependency information, which is information about other assemblies that the assembly depends on or references. Part of the information stored as part of the dependency information is a hash of the referenced assembly's manifest. In general, hashing the manifest of the referenced assembly can be sufficient because that manifest in turn includes hashes of all its constituent files. As with the file hashes, hashes on manifests of referenced assemblies can be computed by the tool emitting the manifest.

The assembly 310 can include a top assembly and any number of modules that make up the assembly 310. The top assembly can be defined as an assembly that includes a metadata section or manifest. The metadata section or manifest can include identity information defining the assembly, assembly references that define the dependencies to other assemblies and module references that define a link to modules or subassemblies, which form the digital content that is to be downloaded. A metadata section 316 is provided in the top assembly 312 that includes information regarding the first assembly 310. The metadata section 316 can further include an identity information component 317 and a file validation digest component 318. The identity information component 317 can further include information about the first assembly 310, while the file validation digest component 318 includes information about the module 314. The identity information component 317 can also include such information as a simple name, version information, operating system or processor information, publisher information, in addition to many other types of information about the digital content or the first assembly 310. The file validation digest component 318 can also include a hash of the module 314.

A top assembly digest 319 can be provided at the end of the top assembly 312. The top assembly digest 319 can contain a hash of the contents of the top assembly 312. Such top assembly hash can be employed to verify that the contents of the top assembly 312 have not been modified, while the hash in the file validation digest component 318 can be used to verify that the module 314 has not been modified.

It is to be appreciated that the digital content can include application programs can include assemblies, some of which refer to other assemblies while executing. As illustrated in FIG. 3, a second assembly 320 can further be provided that depends on the first assembly 310. A metadata section 322 is supplied in the second assembly 320, as part of the digital content that includes information regarding the second assembly 320 and also information about the first assembly 310, which it references during download. The metadata section 322 can include an identity information component 324 and a reference validation digest component 326. The identity information component 324 includes information about the second assembly 324, and the reference validation digest component 326 includes information about the first assembly 310. The identity information component 324 can include such information as a simple name, version information, operating system or processor information, publisher information, in addition to many other types of information about the second assembly 320, as part of the download. The reference validation digest component 326 can include a hash of the metadata section 316 of the top assembly 312 of the first assembly 310. For example, such metadata section 316 can include the hash of the module 314, and the reference validation digest 326 can optionally include a hash value of the top assembly 312. As such creation of a cryptographic hash value can be facilitated for the digital content (e.g., during a download thereof), wherein such hash value cannot be altered (e.g., tampered) by the user.

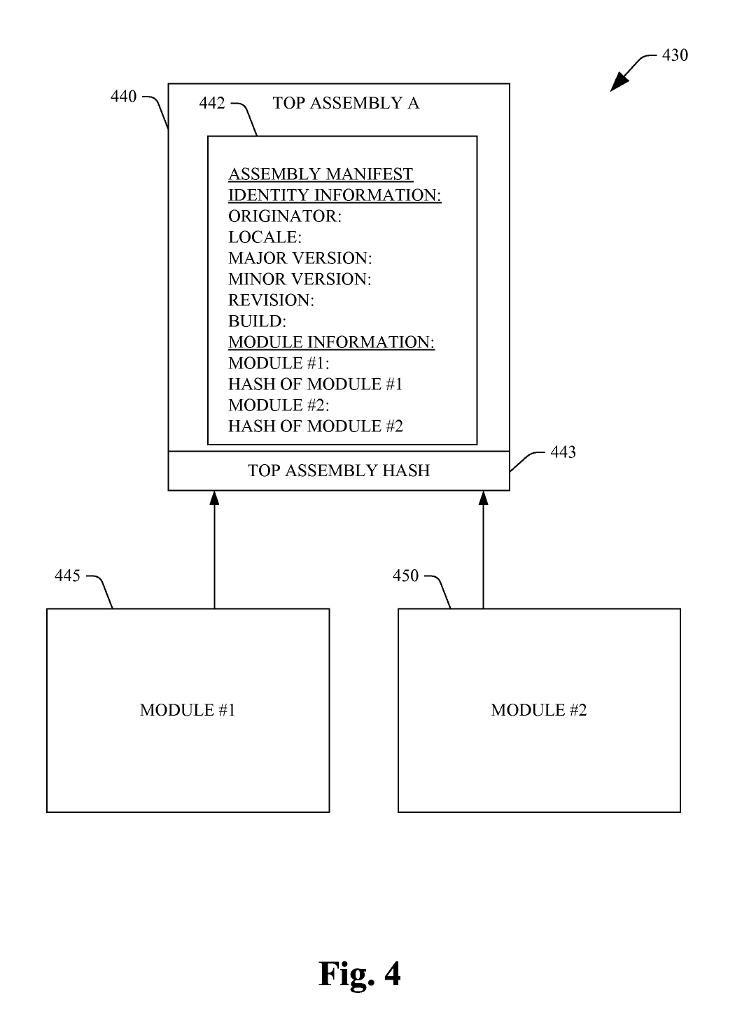

FIG. 4 illustrates the composition of a digital content that can be downloaded and assembled with hash creation in accordance with an aspect of the subject innovation. Such digital content can include assemblies, wherein an assembly 430 is comprised of a top assembly 440, a first module 445 and a second module 450. The top assembly 440 includes a metadata section 442 referred to as an assembly manifest. The assembly manifest 442 includes identity information having the following information: originator name, locale, major version, minor version, revision, build and module information, for example. Other information can be placed in the identity manifest (e.g., operating system). The module information is a list of the modules making up the assembly 430 and the hash of the file contents of each module. Prior to or at runtime, the module hashes in the assembly manifest 442 can be checked against the actual hashes of the first module 445 and the second module 450, using the same hash algorithm, to determine the integrity of the assembly 430. Moreover, the top assembly 440 can include a top assembly hash 443 located at the end of the file. The top assembly hash can be employed to determine if any changes have occurred in the top assembly 440. If the assembly 430 has changed, the application program calling the assembly 430 can choose to abort. In an alternate aspect of the invention, the application program can choose to review the identity information to determine if the change has been invoked by a trustworthy source. The application program can then choose to abort or allow execution of the assembly 430.

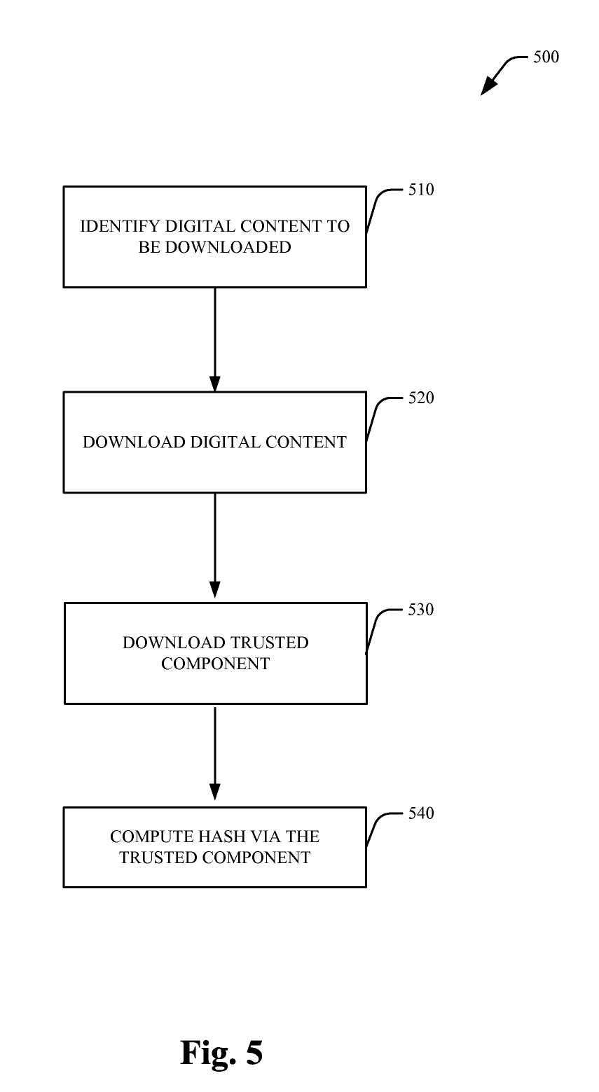

FIG. 5 illustrates a related methodology 500 that typically ensures a fair transaction between a user (e.g., buyer) of digital content from a merchant in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 510 digital data that is to be purchased and downloaded by a user can be identified (e.g., designate the merchant that supplies such content.) Next, and at 520 the digital content can be downloaded to a user's smart or intelligent device. Such download can further include download for a trusted component at 530, wherein the trusted component can compute a cryptographic hash value at 540 for the digital content (e.g., during a download thereof). Such hash value cannot be altered (e.g., tampered) by the user, and hence the trusted component acts as a trusted agent on a user's device.

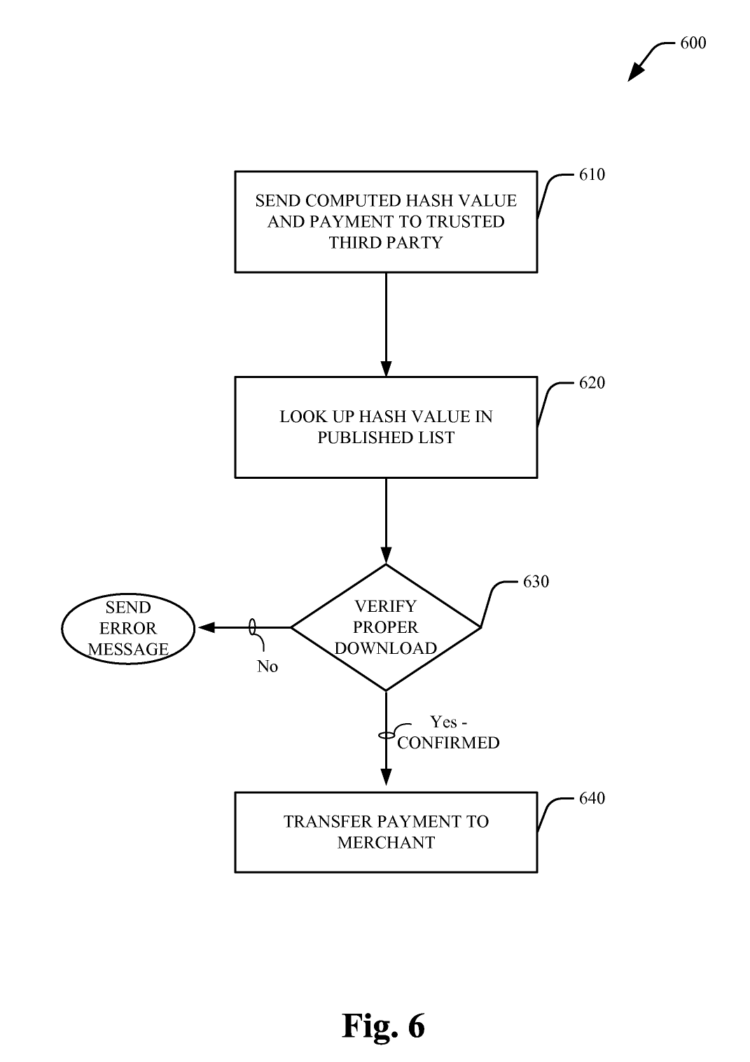

FIG. 6 illustrates a related methodology 600 of payment processing via a trusted third party in conjunction with comparison of computed hash values in accordance with an aspect of the subject innovation. As explained earlier, the cryptographic hash can be computed on the user's machine, and such hash can further be included as part of a transaction log (e.g., key available). The computed hash of the digital content can subsequently be sent in conjunction with payments to a trusted third party, at 610. Upon receipt of the hash content by the trusted third party, such third party can then look up a published list of hash values and digital content at 620, to verify that a correct match exists. After verification of the proper downloaded at 630 content and associated payment, a key can then be supplied to the user. As such, the third party can check mapping of the hash values, to ascertain user's receipt of the digital content and transfer of payment to merchant at 640.

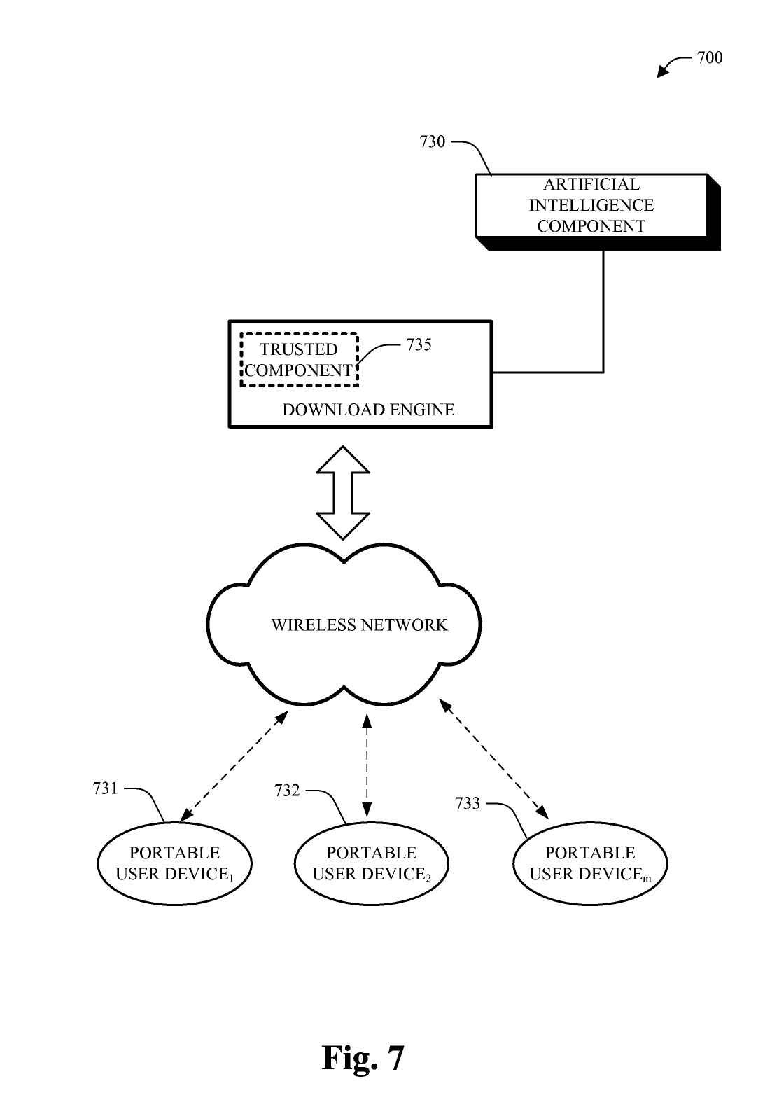

FIG. 7 illustrates an artificial intelligence (AI) component 730 that can be employed to facilitate inferring and/or determining when, where, how to determine a download from repository by employing a trusted component 735 to a plurality of portable user devices 731, 732, 733 (1 to m, where m is an integer) in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 730 can employ any of a variety of suitable AI-based schemes as described supra in connection with facilitating various aspects of the herein described invention. For example, a process for learning explicitly or implicitly how or which digital media should be downloaded can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

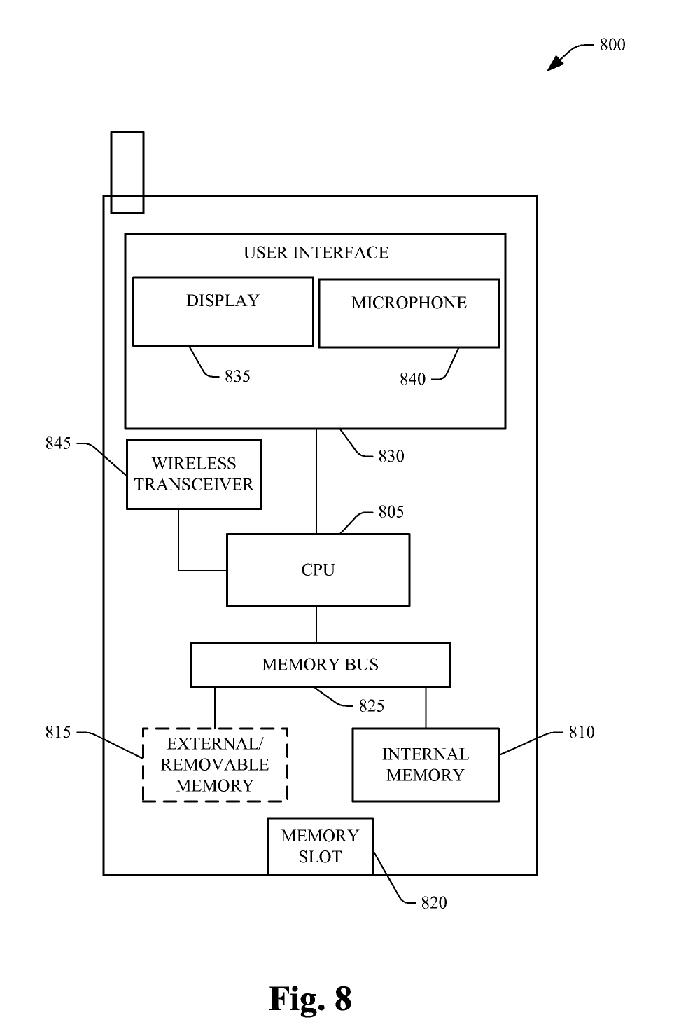

FIG. 8 illustrates a wireless mobile device 800, which can receive a download of digital content in accordance with an aspect of the innovation. The mobile device 800 can access a wireless communication network and download and display digital music. Such mobile device 800 can include electronic processing components including a central processing unit (CPU) 805, internal memory 810, external/removable memory 815, and a memory slot 820. CPU 805 can be various commercially available processors, such as a single core processor, a multi-core processor, or other suitable arrangement of processors. Memory bus 825 can be one of several types of bus structure, or combinations thereof, which can electronically interconnect electronic components including, e.g. CPU 805, internal memory, external memory, and the like, to further interconnect to a system bus, a peripheral bus, and a local bus using a variety of commercially available bus architectures. The internal memory 810 can include read-only memory (ROM), random access memory (RAM), high-speed RAM (such as static RAM), EPROM, EEPROM, and/or the like. Additionally or alternatively, the internal memory 810 can include a hard disk drive, upon which program instructions, data, and the like can be retained. External/Removable memory 815 can include removable hard disk drives, flash drives, USB drives, and the like. Memory Slot 820 can include a universal serial bus (USB), a flash drive input slot, removable hard disk drive slots and other memory or media slots that allow removable memory components to connect to CPU 805 through a memory bus. Memory bus 825 couples electronic processing components including, but not limited to, the internal memory 810 and external/removable memory 815 to CPU 805 and can be one of several types of bus structure, or combinations thereof, that may further interconnect to a system bus, a peripheral bus, and a local bus using a variety of commercially available bus architectures.

Wireless transceiver 845 connects CPU 805 with wireless devices or entities operatively disposed in wireless communication, e.g., digital file repositories, desktops, portable computers, portable data assistants, communications satellites, and devices with WiFi and Bluetooth™ wireless technologies. Thus, the communication can be a predefined structure as with a conventional network or simply an ad hoc communication between at least two devices. Wireless transceiver 845 can also be a removable cellular or dual-mode cellular and WiFi device that can connect to a wireless communication network through a cellular, WLAN or other wireless access point. Such aspect of wireless transceiver 845 enables mobile device 800 to download wireless digital device from a wireless communication network through a standard cellular telephone that can form a wired or wireless connection to CPU 805.

User interface 830 includes at least a graphical display 835 and microphone 840 and is coupled with CPU 805. User interface 830 enables external input of instructions to CPU 805 (e.g. via a keypad or keyboard, a pointing device, for example a mouse or trackball) to configure and run applications (e.g. search applications containing music specific search filters) stored on internal memory 810 or removable/external memory 815. User interface 830 can include a download hotkey, hot-button, or software icon that executes an application automatically connecting a user to a wireless communication network through wireless transceiver 845, and opening a browser at a user specified location containing the digital content for download. User interface 830 can further include features described herein in regard to a user interface for a cellular telephone, such as a sheet music indexing component, selective search component, voice recognition component, audio recognition component or predictive text component. Graphical display 835 can be a CRT or flat panel display e.g. a liquid crystal display (LCD) or plasma display that can graphically display digital sheet music. Microphone 840 is a device that allows the input of analog audio, voice, or speech onto wireless mobile device 800. Inputting analog audio files, voice files, or speech can form the basis for a voice or audio recognition search of a wireless communication network or of the Internet as described, supra.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

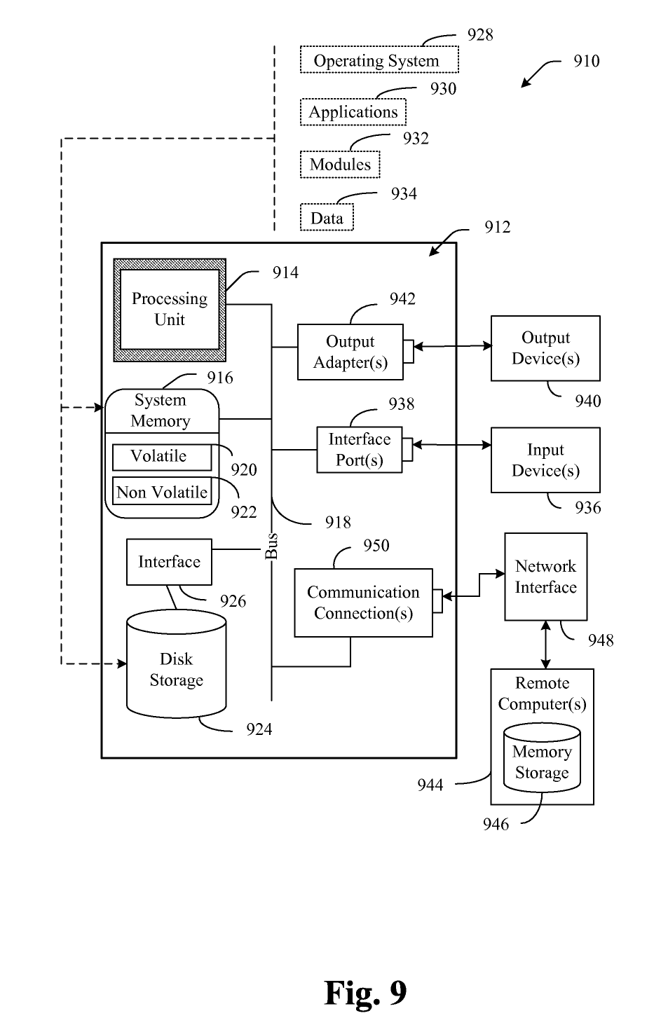

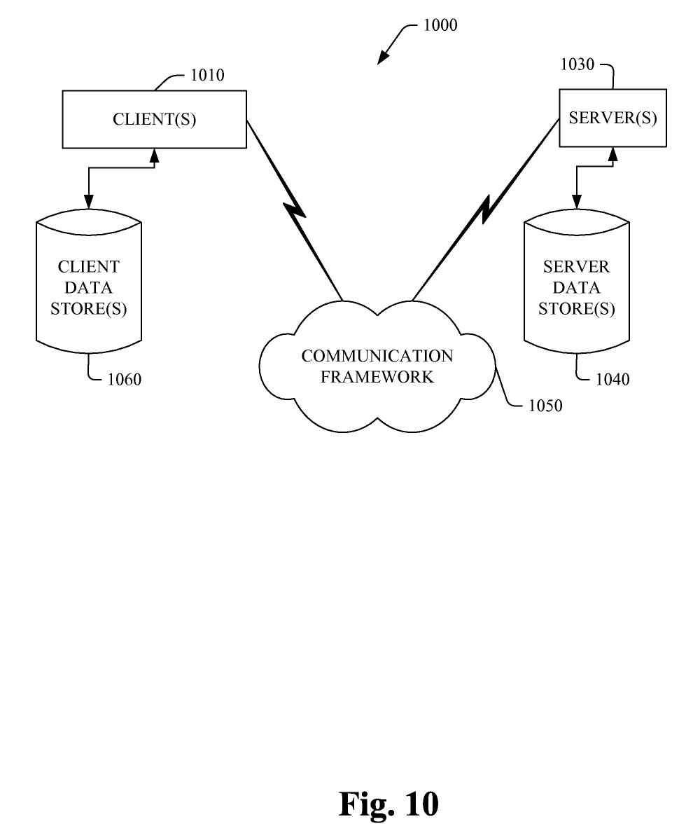

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a processing system of payment for downloaded digital content in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a repository that stores digital content; and
a trusted component that facilitates download of the digital content into a user's device via computation of a cryptographic hash for the digital content.

2. The computer implemented system of claim 1, the cryptographic hash computed on the user's device for transfer to a third party.

3. The computer implemented system of claim 2 further comprising a transaction log that includes the cryptographic hash.

4. The computer implemented system of claim 3 further comprising a key associated with the cryptographic hash.

5. The computer implemented system of claim 3 further comprising a logging component that maintains a log for the digital content and supplies a comparison between a log viewed by the user device and a log used on a server associated with the third party.

6. The computer implemented system of claim 3, the trusted component downloadable to the user's device.

7. The computer implemented system of claim 6 further comprising an artificial intelligence component that infers download of the digital content based on classifiers.

8. The computer implemented system of claim 4, the digital content further comprising a manifest that contains a list of files that make up the digital content.

9. A computer implemented method comprising:
downloading a digital content to a user device;
computing a hash for the digital content via a trusted component; and
verifying payment for the digital content and proper download thereof on to the user device.

10. The computer implemented method of claim 9 further comprising supplying a key for the hash.

11. The computer implemented method of claim 10 further comprising supplying payment for the digital content to a trusted third party.

12. The computer implemented method of claim 10 further comprising looking up published list of hash values to determine existence of a match with the hash.

13. The computer implemented method of claim 11 further comprising comparing a log for download of digital content as viewed by the trusted third part and the user device.

14. The computer implemented method of claim 11 further comprising checking mapping of hash values to ascertain user's receipt of the digital content.

15. The computer implemented method of claim 11 further comprising intelligently downloading the digital content via classifiers.

16. The computer implemented method of claim 11 further comprising assembling parts of the digital content on the user device.

17. The computer implemented method of claim 11 further comprising downloading the trusted component on the user device.

18. The computer implemented method of claim 11 further comprising including the hash as part of a transaction log.

19. The computer implemented method of claim 11 further comprising comparing the hash with values published by a supplier of the digital content.

20. A computer implemented system comprising:
storing means for storing digital content; and
computing means for computing a cryptographic hash that combines purchase of the digital content with payment thereof.
